(19) United States
(12) Patent Application Publication
(10) Pub. No.: US 2011/0300356 A1
(43) Pub. Date: Dec. 8, 2011

(54) Heating Insulating Laminated Glass

(75) Inventors: Atsushi Takamatsu, Mie (JP); Hiromichi Sakamoto, Mie (JP); Kensuke Izutani, Mie (JP)

(73) Assignee: Central Glass Company, Limited, Ube-shi (JP)

(21) Appl. No.: 13/148,010

(22) PCT Filed: Feb. 22, 2010
(86) PCT No.: PCT/JP2010/052637

§ 371 Date: Aug. 4, 2011

(30) Foreign Application Priority Data
Feb. 27, 2009 (JP) 2009045009

(51) Int. Cl. B32B 7/02; B32B 17/06

(52) U.S. Cl. 428/212; 428/426

(57) ABSTRACT

Disclosed is a heat insulating laminated glass that includes at least two glass plates and an intermediate film member by which the at least two glass plates are laminated together, wherein the intermediate film member has two intermediate films and a functional plastic film sheet arranged between the two intermediate films and formed with an infrared reflecting layer and an infrared absorbing layer. This glass attains a high visible light transmittance and good heat insulating properties against solar radiation.

### TECHNICAL FIELD

The present invention relates to a laminated glass in which two glass plates are laminated together by an intermediate film and, more particularly, to a laminated glass with good heat insulating properties.

### BACKGROUND ART

A heat insulating glass with heat-ray (infrared radiation) shielding properties has recently been adopted as an architectural glass material or automotive glass material so as to shield the passage of solar radiation energy into the interior of a room or car and reduce interior temperature increase and cooling load.

Among others, a heat insulating laminated glass having an intermediate film in which conducive ultrafine particles are dispersed is known for not only good heat insulating and ultraviolet shielding properties but also good visible light and radiowave transmission properties. For Example, Patent Document 1 discloses a laminated glass that includes at least two transparent glass plates and an intermediate film arranged between the glass plates, characterized in that fine particles of 0.2 μm or smaller in size, having functional performance such as conductivity, are dispersed in the intermediate film.

There has also been proposed a laminated glass having an infrared reflecting film arranged between two glass plates.

For example, Patent Document 2 discloses a laminated glass that includes two glass plates, an infrared reflecting film of hologram adhered to one of the glass plates and an intermediate film having conductive fine particles dispersed therein and arranged between the glass plates in such a manner that the glass plates are laminated together by the intermediate film with the infrared reflecting film located between the glass plates.

Patent Document 3 discloses a heat insulating laminated glass that includes a first glass plate, an intermediate film member and a second glass plate laminated sequentially together, characterized in that the intermediate film member is an optical interference multilayer sheet that contains a clear intermediate film, an intermediate film having fine particles dispersed therein and two kinds of polymer thin films of different refractive indexes arranged between the intermediate films. It is further disclosed that an ultraviolet absorbing green glass plate may be used as the second glass plate.

Patent Document 4 discloses a heat insulating laminated glass that includes two glass plates, an intermediate film and a polymer resin sheet having a multilayer dielectric film as an infrared reflecting film and laminated between the glass plates by the intermediate film. It is also disclosed that the polymer resin sheet may alternatively be formed with an infrared absorbing film.

Furthermore, Patent Documents 5 and 6 disclose optical filters produced using infrared absorbing pigments.

### Prior Art Documents

### Patent Documents

Patent Document 1: Japanese Laid-Open Patent Publication No. 8-259279

Patent Document 2: Japanese Laid-Open Patent Publication No. 2002-220262

Patent Document 3: Japanese Laid-Open Patent Publication No. 2004-26547

Patent Document 4: Japanese Laid-Open Patent Publication No. 2007-148330

Patent Document 5: Japanese Laid-Open Patent Publication No. 11-326630

Patent Document 6: Japanese Laid-Open Patent Publication No. 2002-122731

### SUMMARY OF THE INVENTION

It is an object of the present invention to provide a laminated glass having a high visible light transmittance and good heat insulating properties against solar radiation.

According to a first aspect f the present invention, there is provided a laminated glass (referred to as a first glass) comprising: at least two glass plates; and an intermediate film member by which the at least two glass plates are laminated together, wherein the intermediate film member has two intermediate films and a functional plastic film sheet arranged between the two intermediate films and formed with an infrared reflecting layer and an infrared absorbing layer.

The first glass may be a heat insulating laminated glass (referred to as a second glass) in which the infrared reflecting layer is in the form of either a multilayer film laminate that has oxide films of high and low refractive indexes alternately laminated on each other, a multilayer film laminate that has two kinds of polymer thin films of different refractive indexes alternately laminated on each other, or a metal film.

The first or second glass may be a heat insulating laminated glass (referred to as a third glass) in which the infrared absorbing layer is in the form of either a plastic film having conductive fine particles dispersed therein, a plastic film laminate that has a plastic film and a resin film formed on a surface of the plastic film and having conductive fine particles dispersed therein, a plastic film having an infrared absorbing pigment dispersed therein, or a plastic film laminate that has a plastic film and a resin film formed on a surface of the plastic film and having an infrared absorbind pigment dispersed therein.

Any one of the first to third glasses may be a heat insulating laminated glass (referred to as a fourth glass) in which one of the intermediate films arranged in contact with the infrared absorbing layer contains therein conductive fine particles as an infrared absorbing material.

Any one of the first to fourth glasses may be a heat insulating laminated glass (referred to as a fifth glass) in which one of the intermediate films arranged in contact with the infrared absorbing layer contains therein either a pigment or a dye as an infrared absorbing material.

Any one of the first to fifth glasses may be a heat insulating laminated glass (referred to as a sixth glass) that has a visible light transmittance of 70% or higher and is used for an automotive window.

According to a second aspect of the present invention, there is provided a heat insulating laminated glass for an automotive window (referred to as a seventh glass), comprising an exterior glass plate, an intermediate film, a plastic film sheet with an infrared reflecting coating, an intermediate film and an interior glass plate laminated together sequentially in order of mention, wherein the laminated glass satisfies the following features: (1) the exterior glass plate has a solar transmittance of 85% or higher; (2) the intermediate film between the exterior glass plate and the plastic film sheet with the infrared reflecting coating has a solar transmittance of 85% or higher; (3) the plastic film sheet with the infrared reflecting coating has a solar reflectance of 20% or higher; (4) the intermediate film between the interior glass plate and the plastic film sheet with the infrared reflecting coating has a solar transmittance of 75% or lower; and (5) the interior glass plate has a solar transmittance of 75% or lower.

The seventh glass may be a heat insulating laminated glass (referred to as an eighth glass) that has a visible light transmittance of 75% or higher.

The seventh glass may be a heat insulating laminated glass (referred to as a ninth glass) in which the infrared reflecting coating is in the foam of either a conductive thin film, a multilayer film laminate that has oxide films of high and low refractive indexes alternately laminated on each other, or a multilayer film laminate that has two kinds of polymer thin films of different refractive indexes alternately laminated on each other.

Any one of the seventh to ninth glasses may be a heat insulating laminated glass (referred to as a tenth glass) in which the intermediate film located interior to the plastic film sheet with the infrared reflecting coating is a resin film having dispersed therein 2.0 to 0.01 wt % of infrared absorbing functional ultrafine particles of 0.2 μm or less in size.

Any one of the seventh to ninth glasses may be a heat insulating laminated glass (referred to as an eleventh glass) in which the interior glass plate is colored.

Any one of the seventh to ninth glasses may be a heat insulating laminated glass (referred to as a twelfth glass) in which the interior intermediate film is colored.

### BRIEF DESCRIPTION OF THE DRAWING

FIG. 1 is a schematic section view of a heat insulating laminated glass according to a first embodiment of the present invention.

FIG. 2 is a schematic section view of a functional plastic film sheet of the heat insulating laminated glass according to the first embodiment of the present invention.

FIG. 3 is a schematic section view showing one structural example of heat insulating laminated glass, in which flat glass plates are used, according to a second embodiment of the present invention.

FIG. 4 is a schematic section view showing another structural example of heat insulating laminated glass, in which curved glass plates are used, according to the second embodiment of the present invention.

FIG. 5 is a schematic view showing heat shrinkage measurements for a plastic film sheet of the heat insulating laminated glass according to the second embodiment of the present invention.

### DETAILED DESCRIPTION

A heat insulating laminated glass according to a first embodiment of the present invention has a high visible light transmittance and a low solar transmittance and thus can be provided as a window glass with very good heat insulating properties. Similarly, a heat insulating laminated glass according to a second embodiment of the present invention can be provided as a window glass material effective for prevention of increase in interior temperature by solar radiation and for reduction of cooling load.

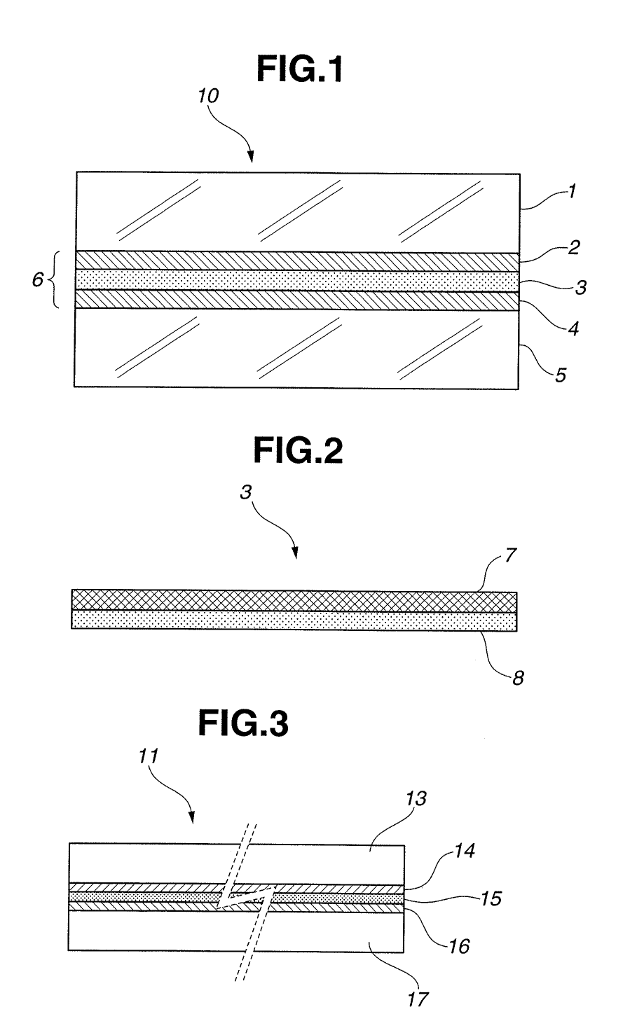

The heat insulating laminated glass according to the first embodiment of the present invention will be described in detail below. In the following description, the wording “first embodiment” will be omitted. This glass is a laminated glass in which at least two glass plates 1 and 5 are laminated together by an intermediate film member 6 as shown in FIG. 1.

As the glass plate 1 (exterior glass plate), it is convenient to use a plate of soda-lime float glass with less coloring component such as metal oxide, called a transparent type or clear type soda-lime glass, which shows good smoothness, less distortion in transmitted image, certain degree of stiffness for less deformation due to window or external force and high visible light transmission and can be available at relatively low cost. Preferably, the glass plate used has a solar transmittance of 85% or higher in order to impart higher performance to the heat insulating laminated glass.

As the glass plate 5 (interior glass plate), there can be used a plate of soda-lime float glass with less coloring component such as metal oxide, called a transparent type or clear type soda-lime glass, as in the case of the glass plate 1. It is however preferable to use as the glass plate 5 a heat-ray absorbing glass plate colored with a metal oxide etc. such that the transmitted color of the glass plate is green, blue, bronze, gray or the like.

When the laminated glass is formed into a curved shape for use in an automotive window etc., both of the glass plates are curved. It is likely that, in the case of inserting a plastic film sheet between two intermediate films and laminating the resulting film laminate between the curved glass plates, wrinkles will occur in the plastic film sheet. In some cases, there occurs separation of a reflective coating from the plastic film sheet.

In order to avoid this problem, it is preferable that the glass plates are curved with a radius of curvature of 0.9 to 3 m.

If the radius of curvature of the curved glass plates is smaller than 0.9 m, it is difficult to prevent the occurrence of wrinkles in the plastic film sheet. If the radius of curvature of the curved glass plates exceeds 3 m, the glass plates become less different in shape from flat ones.

The intermediate film member includes a pair of intermediate films 2 and 4 and a functional plastic film sheet 3 arranged between the intermediate films 2 and 4. Suitable examples of these intermediate films are those formed of ethylene vinyl acetate (EVA) and polyvinyl butyral (PVB).

In order to impart higher performance to the heat insulating laminated glass, it is preferable that the infrared-reflecting-layer-side intermediate film 2 has a solar transmittance of 85% or higher; and the infrared-absorbing-layer-side intermediate film 4 has a solar transmittance of lower than 75%.

As shown in FIG. 2, the functional plastic film sheet 3 has an infrared reflecting layer 7 and an infrared absorbing layer 8. The infrared reflecting layer 7 of the functional plastic film sheet 3 is preferably in the form of either a multilayer film laminate in which oxide films of high and low refractive indexes are alternately laminated on each other, a multilayer film laminate in which two kinds of polymer thin films of different refractive indexes are alternately laminated on each other, or a metal film.

Examples of the multilayer film laminate in which oxide films of high and low refractive indexes are alternately laminated on each other are those obtained by alternately and repeatedly forming films of two or more kinds of oxides selected from TiO₂, Nb₂O₅, Ta₂O₅, SiO₂, Al₂O₃, ZrO₂ and MgF₂. The oxide films can be formed by PVD, sputtering, CVD or the like.

Among these oxides, it is preferable to use Nb₂O₅ or TiO₂ for the high-refractive-index oxide film and SiO₂ for the low-refractive-index oxide film and to set the total lamination number of the oxide films to 4 to 11 in order to attain an infrared reflection coefficient required for the heat insulating effect without loss of transparency.

Examples of the multilayer film laminate in which two kinds of polymer thin films of different refractive indexes are laminated on each other are those obtained by forming thin films of two kinds of polymers selected from polymethyl methacrylate, polyethylene, polystyrene, polycarbonate, a blend of polyvinylidene fluoride and polymethyl methacrylate, a copolymer of ethylene and unsaturated monocarboxylic acid, a copolymer of styrene and methyl methacrylate and the like.

The polymer thin films can be formed by roll coating, flow coating, dipping or the like.

Examples of the metal film as the infrared reflecting layer are those formed of metal such as gold, silver, copper or aluminum. The metal film can be formed by sputtering or the like.

The infrared absorbing layer 8 of the functional plastic film sheet 3 is preferably in the form of either a plastic film having conductive fine particles dispersed therein, a plastic film laminate that has a plastic film and a resin film formed on a surface of the plastic film and having conductive fine particles dispersed therein, a plastic film having an infrared absorbing pigment dispersed therein, or a plastic film laminate having a plastic film and a resin film formed on a surface of the plastic film and having an infrared absorbing pigment dispersed therein.

Examples of the plastic film as the infrared absorbing layer are those obtained by dispersing one or more kinds of conductive fine particles selected from fine particles of metals such as Ag, Al and Ti, fine particles of metal nitrides and metal oxides and fine particles of conductive transparent oxides such as ITO, ATO, AZO, GZO and IZO into a plastic film-forming resin, and then, forming the resulting resin composition into a film shape.

As the plastic film-forming resin, there can suitably be used polyethylene terephthalate, polyethylene naphthalate, polycarbonate, polymethyl methacrylate, polyethersulfone, nylon, polyarylate or cycloolefin polymer.

Examples of the plastic film laminate as the infrared absorbing layer 8 are those obtained by preparing a plastic film of resin selected from polyethylene terephthalate, polyethylene naphthalate, polycarbonate, polymethyl methacrylate, polyethersulfone, nylon, polyarylate, cycloolefin polymer and the like, and then, forming a thin film of resin having dispersed therein one or more kinds selected from fine particles of metals such as Ag, Al and Ti and nitrides and oxides thereof and fine particles of conductive transparent oxides such as ITO, ATO, AZO, GZO and IZO on the plastic film.

Among others, it is preferable to use fine particles of conductive transparent oxide such as ITO, ATO, AZO, GZO or IZO because of its high visible light transmittance.

The resin in which the conductive fine particles are dispersed can be of the same kind as or of different kinds from the resin from which the plastic film is formed.

Further, an acrylic resin can be used as the resin in which the conductive fine particles are dispersed so as to form the resin film as a hard coating.

Alternatively, the infrared absorbing layer 8 may be in the form of the plastic film having dispersed therein the pigment or dye or the plastic film laminate in which the resin film having dispersed therein the pigment or dye is formed on the plastic film as mentioned above.

Any of various known pigments and dyes can be used as the pigment or dye. Examples of the dye are anthraquinone dyes, azo dyes, acridine dyes and indigoid dyes. Examples of the pigment are carbon black, red iron oxide, phthalocyanine blue, phthalocyanine green, iron blue, hydrozincite, azo pigments and threne pigments.

More specifically, the plastic film or plastic film laminate can be obtained as the infrared absorbing layer 8 by dispersing one or more of the above pigments and dyes into a resin selected from polyethylene terephthalate, polyethylene naphthalate, polycarbonate, polymethyl methacrylate, polyethersulfone, nylon, polyarylate, cycloolefin polymer etc., and then, forming the resulting resin compolstion into a film shape, or by applying a thin film of resin in which one or more of the above pigments and dyes are dispersed to a plastic film of polyethylene terephthalate, polyethylene naphthalate, polycarbonate, polymethyl methacrylate, polyethersulfone, nylon, polyarylate, cycloolefin polymer etc.

As the infrared reflecting layer 7 can be formed by thin-film forming process, it is feasible to produce the functional plastic film sheet 3 by preparing the infrared absorbing layer 8 as a substrate and forming the infrared reflecting layer 7 as a thin film coating on the infrared absorbing layer 8.

If the thickness of the infrared absorbing layer 8 is smaller than 30 μm, such a thin-film layer is difficult to handle and is likely to get curled under stress of the infrared reflecting layer 7 or the after-mentioned hard coating. On the other hand, there arise appearance defects due to poor degassing during lamination process if the thickness of the infrared absorbing layer 8 is greater than 200 μm. It is thus preferable that the infrared absorbing layer 8 has a thickness of 30 to 200 μm.

In order to improve the heat insulating properties of the heat insulating laminated glass, it is preferable that the intermediate film 4 located between the infrared absorbing layer 8 and the glass plate 5, i.e., arranged in contact with the infrared absorbing layer 8 contains therein conducive fine particles as an infrared absorbing material.

It is also preferable to color the intermediate film 4 with at least one selected from the above various kinds of pigments and dyes in order to improve the heat insulating properties of the heat insulating laminated glass.

Furthermore, the heat insulating laminated glass preferably has a visible light transmittance of 70% or higher as determined according to JIS R 3212 (1998) and can suitably be used for an automotive window.

The first embodiment of the present invention will be described in more detail below, by way of the following examples, with reference to FIGS. 1 and 2.

### Example 1

A flat heat insulating laminated glass 1 was produced by laminating a glass plate 1, an intermediate film 2, a functional plastic film sheet 3, an intermediate film 4 and a glass plate 5 sequentially in this order as shown in FIG. 1.

Herein, a transparent float glass plate of 2 mm in thickness was used as the glass plate 1; a heat-ray absorbing green glass plate of 2 mm in thickness was used as the glass plate 5; and colorless transparent PVB films of 0.38 mm in thickness were used as the intermediate films 2 and 4.

The functional plastic film sheet 3 was prepared by the following procedure.

A transparent PET film of 100 μm in thickness was provided. A hard coating film containing an acrylic resin as a main component and having fine particles of tin-doped indium oxide (ITO) dispersed therein was formed by roll coating as an infrared absorbing layer 8 on one side of the plastic film in such a manner that the hard coating film had a thickness of 5 μm after curing

A multilayer film laminate of different refractive index dielectric materials was formed as an infrared reflecting layer 7 on the other side of the plastic film on which the hard coating film had not been formed.

More specifically, the multilayer film laminate of different refractive index dielectric materials was formed by sequentially sputtering a TiO₂ film (thickness: 105 nm), a SiO₂ film (thickness: 175 nm), a TiO₂ film (thickness: 105 nm), a SiO₂ film (thickness: 175 nm) and a TiO₂ film (thickness: 105 nm).

The heat insulating laminated glass was then completed by the following procedure.

Step 1: The glass plate 1, the intermediate film 3, the functional plastic film sheet 3, the intermediate film 4 and the glass plate 5 were laminated on each other in this order.

At this time, the functional plastic film sheet 3 was placed in such a manner that: the side of the plastic film sheet 3 on which the hard coating film containing acrylic resin as the main coating and having ITO fine particles dispersed therein had been formed as the infrared absorbing layer 8 was situated toward the heat-ray absorbing green glass plate 5; and the side of the plastic film sheet 3 on which the multilayer film laminate of different refractive index dielectric materials had been formed as the infrared reflecting layer 7 was situated toward the glass plate 1.

Step 2: The laminate of the glass plate 1, the intermediate film 3, the functional plastic film 3, the intermediate film 4 and the glass plate 5 obtained in Step 1 was placed in a vacuum bag. The vacuum bag was degassed and vacuumed using a vacuum pump.

Step 3: The vacuum bag vacuumed in Step 2 was placed in an autoclave and subjected to heating and pressing treatment at 90° C. for 30 minutes.

Step 4: The inside of the autoclave was returned to atmospheric pressure and temperature conditions. The vacuum bag was taken out of the autoclave. The inside of the vacuum bag was returned to atmospheric pressure conditions. The resulting heat insulating laminated glass, in which the glass plate 1, the intermediate film 3, the functional plastic film sheet 3, the intermediate film 4 and the glass plate 5 were bonded together, was taken out of the vacuum bag.

Step 5: This laminated glass was again placed in the autoclave and subjected to heating and pressing treatment at 130° C. for 30 minutes. The inside of the autoclave was returned to atmospheric pressure and temperature conditions. The heat insulating laminated glass was taken out of the autoclave.

In the present example, the thus-produced heat insulating laminated glass had a solar transmittance of 45.7% and a visible light transmittance of 76.7%.

### Example 2

Each of a transparent float glass plate of 2 mm in thickness and a heat-ray absorbing green glass plate of 2 mm in thickness was cut into an automotive front glass shape (upper side: about 1000 mm, lower side: about 1500 mm, height: about 900 mm). The cut glass plates were heated at a temperature higher than or equal to their respective softening points, subjected to bending and thereby curved into the same shape. The curved transparent float glass plate was used as a glass plate 1, and the curved heat-ray absorbing green glass plate was used as a glass plate 5.

A colorless transparent PVB film of 0.38 mm in thickness was used as an intermediate film 2 as in the case of Example 1. On the other hand, a transparent PVD film of 0.76 mm in thickness, having fine particles of antimony-doped tin oxide (ATO) dispersed therein, was used as an intermediate film 4.

A functional plastic film sheet 3 was prepared as follows. A transparent PET film of 0.80 μm in thickness was provided. A hard coating film containing an acrylic resin as a main component and having ATO fine particles dispersed therein was formed by roll coating as an infrared absorbing layer 8 on one side of the plastic film in such a manner that the hard coating film had a thickness of 5 um after curing.

A multilayer film laminate of different refractive index dielectric materials was formed on the hard coating film as an infrared reflecting layer 7.

More specifically, the multilayer film laminate of different refractive index dielectric materials was formed by sequentially sputtering a NbO film (thickness: 115 nm), a SiO₂ film (thickness: 175 nm), a NbO film (thickness: 115 nm), a SiO₂ film (thickness: 175 nm) and a Nb₂O₅ film (thickness: 115 nm).

Using the above-mentioned glass plate 1, intermediate film 2, functional plastic film sheet 3, intermediate film 4 and glass plate 5, a heat insulating laminated glass was produced in the same manner as in Example 1.

Herein, the functional plastic film sheet 3 was placed in such a manner that: the infrared absorbing layer 8 was situated toward the heat-ray absorbing green glass plate 5; and the multilayer film of different refractive index dielectric materials as the infrared reflecting layer 7 was situated toward the glass plate 2 as in the case of Example 1

In the present example, the thus-produced heat insulating laminated glass had a solar transmittance of 44.0% and a visible light transmittance of 75.6%.

### Example 3

A flat heat insulating laminated glass 1 was produced by laminating a glass plate 1, an intermediate film 2, a functional plastic film 3, an intermediate film 4 and a glass plate 5 sequentially in this order in the same manner as in Example 1 except for using a PET film having fine particles of ITO dispersed therein as a filler as the infrared absorbing layer 8.

The thus-produced heat insulating laminated glass had a solar transmittance of 44.2% and a visible light transmittance of 74.5%.

Next, the heat insulating laminated glass according to the second embodiment of the present invention will be described in detail below. In the following description, the wording “second embodiment” will be omitted.

The heat insulating laminated glass according to the present invention is a laminated glass in which an exterior glass plate, an exterior intermediate film, a plastic film sheet with an infrared reflecting coating, an interior intermediate film and an interior glass plate are laminated together sequentially together in this order.

FIG. 3 is a schematic section view showing the configuration of one example of the heat insulating laminated glass according to the present invention.

It is herein noted that, in the present invention, the solar transmittance is a value determined according to JIS R 3106 (1998).

As the exterior glass plate, there can suitably be used a soda-lime float glass plate having a solar transmittance of 85% or higher, a tempered glass plate obtained by tempering the soda-lime float glass plate or a curved glass plate obtained by bending the soda-lime float glass plate into a curved shape.

Suitable examples of the exterior intermediate film are those formed of colorless transparent resins such as ethylene-vinyl acetate (EVA) and polyvinyl butyral (PVB).

In order to exert the effect of the infrared reflecting coating and make full use of the heat insulating properties of the laminated glass, it is preferable that the exterior intermediate film has a solar transmittance of 85% or higher.

As the plastic film sheet with the infrared reflecting coating, there can be used those in which the infrared reflecting coating is applied to a transparent plastic film. It is preferable that the plastic film sheet with the infrared reflecting coating has a solar reflectance of 20% or higher.

Suitable examples of the plastic film of the plastic film sheet with the infrared reflecting coating are those formed of resin selected from polyethylene terephthalate, polyethylene naphthalate, polycarbonate, polymethyl methacrylate, polyethersulfone, nylon, polyarylate and cycloolefin polymer.

If the thickness of the plastic film is smaller than 30 μm, the plastic film is difficult to handle and is likely to get curled under stress of the infrared reflecting coating or the after-mentioned hard coating. On the other hand, there arise appearance defects due to poor degassing during lamination process if the thickness of the plastic film is greater than 200 μm. It is thus preferable that the plastic film has a thickness of 30 to 200 μm.

When the laminated glass has a curved shape for use in an automotive window etc., both of the glass plates are curved. It is likely that, in the case of inserting the plastic film sheet between two intermediate films and laminating the resulting film laminate between the curved glass plates, wrinkles will occur in the plastic film sheet. In some cases, there occurs separation of the reflective coating from the plastic film sheet.

In order to avoid this problem, it is preferable that the plastic film sheet satisfies either of the following conditions (A), (B) and (C) in the case where the glass plates are curved with a radius of curvature of 0.9 to 3 m.

The reason for setting the radius of curvature of the curved glass plates to 0.9 to 3 mm is that: it is different to prevent the occurrence of wrinkles in the plastic film sheet if the radius of curvature of the curved glass plates is less than 0.9 mm; and the curved glass plates becomes less different in shape from flat ones so that there is no need to satisfy the condition (A), (B), (C) if the radius of curvature of the glass plates exceeds 3 m.

(A) The plastic film sheet with the infrared reflecting coating has a heat shrinkage of 0.5 to 3% in a temperature range of 90 to 150° C.

(B) The plastic film sheet has an elastic modulus of 30 to 2000 MPa in a temperature range of 90 to 150° C.

(C) The plastic film sheet has an elongation of 0.3% or less in a temperature range of 90 to 150° C. as measured under the application of a tensile load of 10 N per 1 mm width of the plastic film sheet.

If the heat shrinkage of the plastic film sheet with the infrared reflecting coating is less than 0.5% in the temperature range of 90 to 150° C., the plastic film sheet with the infrared reflecting coating becomes too loose at peripheries of the curved glass plates so that wrinkles occurs in the plastic film sheet as appearance defects.

If the heat shrinkage of the plastic film sheet with the infrared reflecting coating exceeds 3% in the temperature range of 90 to 150° C., the infrared reflecting coating cannot withstand shrinkage of the film sheet so that cracks occurs in the coating as appearance defects.

For the above reasons, the heat shrinkage of the plastic film sheet with the infrared reflecting coating is preferably in the range from 0.5 to 3% in the temperature range of 90 to 150° C. in order to prevent the occurrence of wrinkles in the plastic film sheet with the infrared reflecting coating or cracks in the infrared reflecting coating during lamination process. More preferably, the heat shrinkage of the plastic film sheet with the infrared reflecting coating is in the range of 0.5 to 2%.

As the transparent plastic film, there can suitably be used those formed by stretching process such as successive biaxial stretching process due to the fact that a stress developed during film formation process remains in the inside of the stretched plastic film so that the stretched plastic film tends to get contracted upon relief of the stress by thermal treatment.

In order to prevent the occurrence of wrinkles in the plastic film sheet even under the high temperature conditions of 90 to 150° C. during high-temperature and high-pressure treatment in an autoclave, the elastic modulus of the plastic film sheet is preferably 30 to 2000 MPa, more preferably 30 to 500 MPa, in the temperature range of 90 to 150° C.

The elastic modulus of the plastic film sheet can be determined, from a stress-strain curve in the temperature range of 90 to 150° C., using a viscoelasticity measurement device. If the elastic modulus of the plastic film sheet is smaller than 30 MPa, the plastic film sheet tends to get deformed even by a small external force so that wrinkles are likely to occur as appearance defects in the whole surface of the laminated glass. If the elastic modulus of the plastic film sheet is greater than 2000 MPa, it becomes a cause of poor degassing due to incomplete air discharge from the space between the plastic film and the intermediate films during the high-pressure and high-temperature in the autoclave.

It is alternatively preferable that the elongation of the plastic film sheet is 0.3% or less as measured by the application of a tensile load of 10 N per lm width of the plastic film sheet in the temperature range of 90 to 150° C., in order to prevent the occurrence of wrinkles in the plastic film sheet even under the high temperature conditions of 90 to 150° C. during high-temperature and high-pressure treatment in the autoclave.

Herein, the tensile load of 10 N applied per 1 m width of the plastic film sheet corresponds to a tension that occurs on the plastic film sheet in such a manner as to extend the plastic film sheet when the plastic film sheet held between the intermediate films is subjected to high-pressure and high-temperature treatment in an autoclave for thermal bonding of the plastic film sheet to the glass plates via the intermediate films.

The elongation of the plastic film sheet can be measured through the following steps 1 to 5.

Step 1: The plastic film is cut to a size of 15 mm in length and 5 mm in width as a measurement sample. Fixing jigs are attached to opposite ends of the measurement sample and adjusted in such a manner as to set the length of the measurement sample exposed between the fixing jigs to 10 mm.

Step 2: The measurement sample is placed under a tensile load of 10 N per 1 mm width of the plastic film sheet. Namely, a load of 0.05 N is applied to the measurement sample set in Step 1.

Step 3: In this state, the length L0 of the measurement sample between the fixing jigs is measured.

Step 4: The measurement sample is heated at a rate of 5° C./min to a given temperature within the range of 90 to 150° C. Then, the length L of the measurement sample between the fixing jigs is measured at this measurement temperature.

Step 5: The elongation (%) is determined by the following equation: (LO−L)/L×100.

It also is preferable that a coating of a silane coupling agent is formed on a side of the plastic film opposite from the side on which the infrared reflecting coating is formed.

Herein, the silane coupling agent is a material that has the function of providing good adhesion between the plastic film and the intermediate film. As the silane coupling agent, there can be used those having an amino group, an isocyanate group, an epoxy group and the like.

It is further preferable that a hard coating film is formed between the plastic film and the infrared reflecting coating.

Depending on the kind of the plastic film between the intermediate films, there arise problems that: the plastic film has poor adhesion to the intermediate films; and white turbidity occurs upon the formation of the infrared reflecting coating. These problems can be solved by the formation of the hard coating film at the interface between the plastic film and the infrared reflecting coating. In the case of using a conductive thin film as the infrared reflecting coating, the conductive thin film can suitably be in the form of a metal or alloy film of metal such as Ag, Au, Cu, Al, Pd, Pt, Sn, In, Zn, Ti, Cd, Fe, Co, Cr or Ni or alloy thereof or a film of conductive metal oxide such as antimony-doped tin oxide or tin-doped indium oxide.

Furthermore, it is preferable that the infrared reflecting coating on the plastic film is in the form of a multilayer film laminate of different refractive index dielectric materials or a multilayer film laminate of different refractive index polymers in order to transmission of electromagnetic waves therethrough for broadcasts and communications.

Examples of the multilayer film of different refractive index dielectric materials or polymers are those obtained by alternately arranging films of refractive index n1 and of refractive index n2.

When the infrared reflecting coating is in the form of the multilayer film laminate of alternating high- and low-refractive-index oxide films, the oxide film layers are each preferably of at least one kind of dielectric selected from TiO₂, Nb₂O₅, Ta₂O₅, SiO₂, Al₂O₃, ZrO₂ and MgF₂.

It is particularly preferable, in the case of using SiO₂ for the low-refractive-index oxide film and at least one or more kinds of dielectrics selected from TiO₂, Nb₂O₅ and Ta₂O₅ for the high-refractive-index oxide film, to set the total lamination number of the oxide films to 4 to 11 so that the infrared reflecting coating can be favorably obtained with near-infrared reflectivity.

For more effective heat insulating properties, it is preferable that the infrared reflecting coating has 4 to 11 dielectric film layers laminated together and shows a maximum reflectance of higher than 50% in a wavelength range of 900 to 1400 nm so as to satisfy the following conditions (1) and (2).

(1) nₑₘₐₓ<nₒₘᵢₙ or nₒₘₐₓ<nₑₘᵢₙ where, when the dielectric film layers are numbered in order from the plastic film side, nₑₘₐₓ and nₑₘᵢₙ represent maximum and minimum values of the refractive index of the even-numbered dielectric film layers, respectively; and nₒₘₐₓ and nₒₘᵢₙ represent maximum and minimum values of the refractive index of the odd-numbered dielectric film layers, respectively.

(2) 225 nm≦ni·di≦350 nm relative to infrared rays having a wavelength λ of 900 to 1400 nm where nᵢ and dᵢ represent values of the reflective index and thickness of the i-th numbered dielectric film layer, respectively.

When the infrared reflecting coating is in the form of the multilayer film laminate of alternating different refractive index polymer thin films, the polymer thin films are preferably formed of polyethylene terephthalate, polyethylene naphthalate, polycarbonate, polymethyl methacrylate, polyethersulfone, nylon, polyarylate, cycloolefin polymer and the like. It is further preferable to set the total lamination number of the alternating two kinds of polymer films to 5 to 200.

Suitable examples of the interior intermediate film are those formed of ethylene-vinyl acetate (EVA) and polyvinyl butyral (PVB). It is preferable that the interior intermediate film has a solar transmittance of 75% or lower by containing infrared absorbing fine particles in the interior intermediate film, or coloring the interior intermediate film with a coloring agent, within a range that does not interfere with the visible light transmittance of the interior intermediate film.

As the infrared absorbing fine particles, there can be used fine particles of metals such as Ag, Al and Ti and nitrides and oxides thereof and fine particles of conductive transparent oxides such as ITO, ATO, AZO, GZO and IZO. At least one kind selected from the above fine particles can be contained in the interior intermediate film 16 for improvement in heat insulating properties.

Among others, fine particles of conductive transparent oxide such as ITO, ATO, AZO, GZO or IXO are particularly preferred.

There can be used any known pigment or dye as the coloring agent to color the EVA or PVB film.

Examples of the dye are anthraquinone dyes, azo dyes, acridine dyes and indigoid dyes. Examples of the pigment are carbon black, red iron oxide, phthalocyanine blue, phthalocyanine green, iron blue, hydrozincite, azo pigments and threne pigments.

Alternatively, the interior intermediate film may be in the form of a film laminate in which a colored polyvinyl acetal film, prepared by coloring a polyvinyl acetal film with any of the above dyes and pigments, is laminated on the EVA or PVB film.

As the interior glass plate, there can suitably be used heat-ray absorbing glass plates of which the transmitted color is green, blue, bronze, gray or the like and having a solar transmittance of lower than 75%.

Among the heat-ray absorbing glass plates, a green glass plate is particularly preferred because of its function to shield ultravioret radiation that is harmful to human body.

Herein, a surface of the intermediate film is subjected to embossing and thereby formed with some roughness in order to prevent the occurrence of devitrification or bubble defects due to poor degassing during lamination process. It is however difficult to perform optical measurement on such an embossed intermediate film as light scattering occurs at the film surface. Thus, the visible light transmittance and solar transmittance of the intermediate film are determined as follows. The surface of the embossed intermediate film is flattened by sandwiching the embossed intermediate film between PET films, sandwiching these films between flat glass plates, placing the resulting laminate in a bag, discharging air from the bag, subjecting the laminate in the bag to pressing and heating treatment in an autoclave as in the case of producing the laminated glass, and then, peeling off the PET films from the intermediate film. This surface-flattened intermediate film is tested as a measurement sample for its visible light transmittance and solar transmittance according to JIS R 3106 (1008) as in the case of the glass plate.

It is preferable that the laminated glass has a visible light transmittance of 70% or higher according to JIS R 3106 for bright interior and good viewability. It is further preferable that the laminated glass has a visible light transmittance of 70% or higher according to JIS R 3212 (1998) for use in a window glass for vehicle driving.

The second embodiment of the present invention will be described in more detail below, by way of the following examples, with reference to FIGS. 3 to 5. It is herein noted that the following comparative examples are provided as references contrast to the following examples.

### Example 1

A flat heat insulating laminated glass of FIG. 3 was produced.

Herein, a transparent float glass plate of 3 mm in thickness was used as an exterior glass plate 13. This glass plate had a solar transmittance Te of 85.8% and a visible light transmittance Tv of 90.4%. Further, a heat-ray absorbing green glass plate of 3 mm in thickness was used as an interior glass plate 17. This glass plate had a solar transmittance Te of 62.7% and a visible light transmittance Tv of 81.2%.

As an exterior intermediate film 14, a colorless transparent PVB film of 0.38 mm in thickness was used. This intermediate film had a solar transmittance Te of 90.8% and a visible light transmittance Tv of 94.3%.

On the other hand, a PVB film of 0.76 mm in thickness having fine particles of ITO dispersed therein was used as an interior intermediate film 16. This intermediate film had a solar transmittance Te of 64.3% and a visible light transmittance Tv of 82.5%.

As the PVD films used as the exterior and interior intermediate films 14 and 16 had been subjected to embossing before the production of the laminated glass, surface-flattened samples of these intermediate films were each prepared for optical measurement by sandwiching the PVD film between PET films, sandwiching these films between flat glass plates of 3 mm in thickness, placing the resulting laminate in a bag, discharging air from the bag, subjecting the laminate in the bag to pressing and heating treatment in an autoclave as in the case of producing the laminated glass, and then, peeling off the PET films from the PVD film.

Using these surface-flattened PVD film samples, the visible light transmittance and solar transmittance of the PVD films were measured according to JIS R 3106 (1998).

Further, a plastic film sheet 15 with an infrared reflecting coating was prepared. The infrared reflecting film was herein formed as an infrared reflecting coating of dielectric materials of different refractive indexes by sequentially sputtering a TiO₂ film (thickness: 105 nm), a SiO₂ film (thickness: 175 nm), a TiO₂ film (thickness: 105 nm), a SiO₂ film (thickness: 175 nm) and a TiO₂ film (thickness: 105 nm). This plastic film sheet with the infrared reflecting coating had a solar reflectance of 35.5%.

Using the above-mentioned exterior glass plate, exterior intermediate film, infrared reflecting coated plastic film sheet, interior intermediate film and interior glass plate, the heat insulating laminated glass was completed by the following procedure.

Step 1: The plastic film sheet 15 with the infrared reflecting coating was inserted and laminated between the exterior intermediate film 14 and the interior intermediate film 16.

Step 2: The laminate of the three films obtained in Step 1 was subjected to pressing and heating treatment by passing between two heating rolls. There was thus obtained a three-layer intermediate film member in which the exterior intermediate film 14, plastic film sheet 15 with the infrared reflecting coating and the interior intermediate film 16 were bonded together.

Step 3: The three-layer intermediate film member obtained in Step 2 was placed on the exterior glass plate 13. Subsequently, the interior glass plate 17 was placed on the three-layer intermediate film member. The laminate of the glass plate, the intermediate film member and the glass plate was placed in a vacuum bag. The vacuum bag was degassed using a vacuum pump connected thereto via a tube.

Step 4: The degassed vacuum bag was placed in an autoclave and subjected to pressing and heating treatment at 90° C. for 30 minutes, thereby bonding the glass plates to the intermediate film member.

Step 5: The inside of the autoclave was returned to atmospheric pressure and temperature conditions. The vacuum bag was taken out of the autoclave. The inside of the vacuum bag was returned to atmospheric pressure conditions. Then, the resulting heat insulating laminated glass was taken out of the vacuum bag.

Step 6: This heat insulating laminated glass was again placed in the autoclave and subjected to pressing and heating treatment at 130° C. for 30 minutes.

Step 7: The inside of the autoclave was returned to atmospheric pressure and temperature conditions. The heat insulating laminated glass was taken out of the autoclave.

The thus-produced heat insulating laminated glass had a solar transmittance of 37.8% and a visible light transmittance of 70.1%.

### Example 2

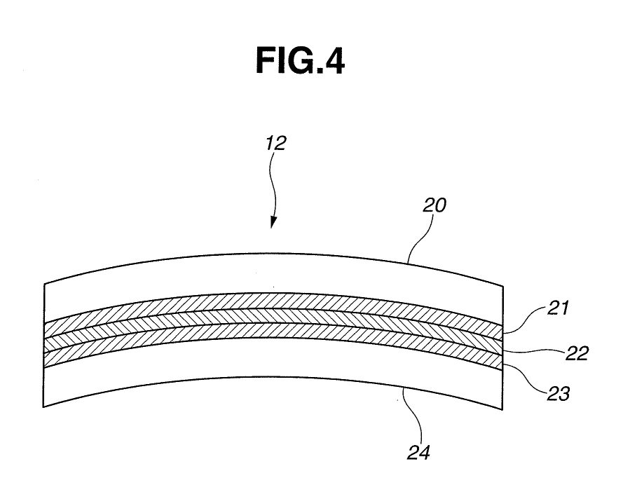

A curved heat insulating laminated glass 12 of FIG. 4 was produced. As an exterior glass plate 20, a transparent float glass plate of 2 mm in thickness was used. This glass plate had a solar transmittance Te of 87.8% and a visible light transmittance Tv of 90.8%.

A heat-ray absorbing green glass plate of 2 mm in thickness was used as an interior glass plate 24. This glass plate had a solar transmittance Te of 70.7% and a visible light transmittance Tv of 84.6%.

These two glass plates were cut into a substantially trapezoidal shape (upper side: about 1000 mm, lower side: about 1500 mm, height: about 900 mm), heated at a temperature higher than or equal to their respective softening points and curved by bending into the same shape. The minimum and maximum values of the curvature radius of the curved glass plates were 0.9 m and 1 m, respectively.

Further, a plastic film sheet 22 with an infrared reflecting coating was prepared. The infrared reflecting coating was herein formed as an infrared reflecting coating of dielectric materials of different refractive indexes on a PET film of 50 μm in thickness in the same manner as in Example 1. This plastic film sheet 22 with the infrared reflecting coating had a heat shrinkage of 1.5% in an MD direction and 1% in a TD direction.

The heat insulated laminated glass was produced in the same manner as in Example 2 except for using the above-mentioned plastic film sheet 22 with the infrared reflecting coating and the curved glass plates 20 and 24. It is herein noted that, in FIG. 4, reference numerals 21 and 22 denote exterior and interior intermediate films, respectively.

The heat shrinkage was determined as follows according to JIS C 2318.

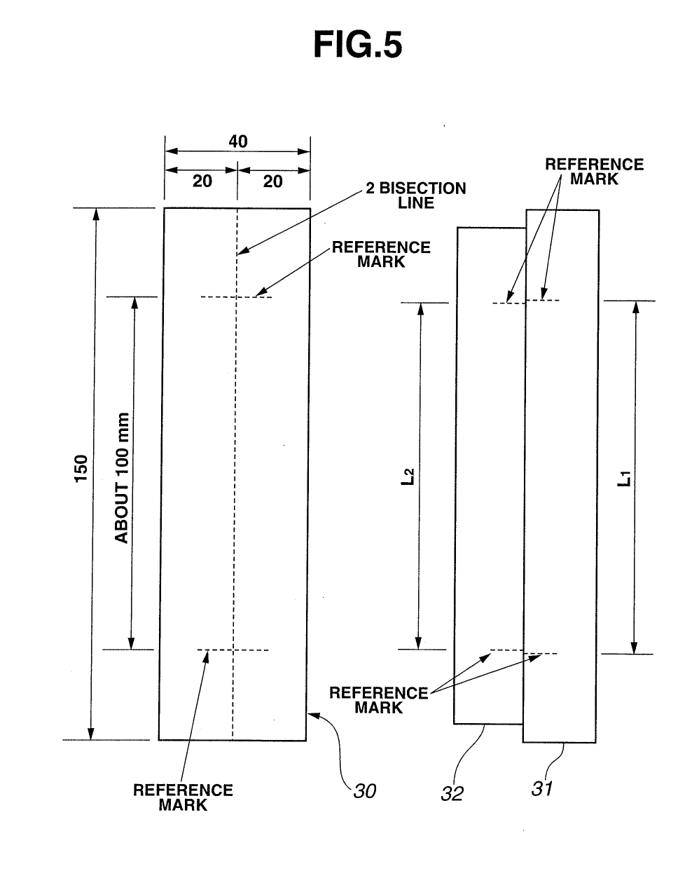

As shown in FIG. 5, a rectangular film sample 30 of 150 mm in length and 40 mm in width was cut out from the plastic film sheet. Using a diamond pen, reference marks were indicated at around centers of the rectangular film sample 30 in respective width directions with an interval of about 100 mm therebetween. After indicating the reference marks, the rectangular film sample 30 was cut into two equal test pieces of 150 mm×20 mm in size.

One of the two equal test pieces was vertically hung in a hot-air circulation thermostat oven, heated to a measurement temperature of 130° C. at a temperature increase rate of about 5° C./min and maintained at such a measurement temperature of 130° C. for about 30 minutes.

The hot-air circulation thermostat oven was then opened to the air so that the heated test piece was subjected to natural cooling at a cooling rate of about 20° C./min and maintained at a room temperature for 30 minutes.

For the above temperature measurements, a thermocouple thermometer was used; and the temperature distribution in the hot-air circulation thermostat oven was set within ±1° C.

On the other hand, the other test piece was maintained at a room temperature.

The distance L1, L2 between the reference marks of each of the test piece 31, which had been maintained at room temperature, and the test piece 32, which had been heated at the measurement temperature, was measured using a scanning laser microscope “1LM21D” manufactured by Lasertec Corporation.

The heat shrinkage value (%) was calculated according to the following equation:

(L1−L2)/L1×100.

Herein, three rectangular film samples 30 were cut out for each of the MD and TD directions of the plastic film sheet; and the heat shrinkage was determined as an average of the heat shrinkage values of these three rectangular film samples as measured by the above measurement procedure.

The produced curved heat insulating laminated glass 12 had good appearance with no wrinkles in the plastic film sheet with the infrared reflecting coating and no cracks in the infrared reflecting coating. Further, the produced heat insulating laminated glass had a solar transmittance of 42.2% and a visible light transmittance of 79.5%.

In this way, it was possible in the present example to obtain the curved heat insulating laminated glass with good appearance and with no wrinkles in the plastic film sheet with the infrared reflecting coating and no cracks in the infrared reflecting coating.

### Example 3

A heat insulating laminated glass was produced in the same manner as in Example 2 except for using, in the plastic film sheet with the infrared reflecting coating, a PET film of 100 μm in thickness having an elongation of 0.02% in a MD direction and 0.13% in a TD direction as measured under the application of a tensile load of 10 N per 1 mm width of the plastic film sheet.

It was thus possible to obtain the curved heat insulating laminated glass with good appearance and with no wrinkles in the plastic film sheet with the infrared reflecting coating and no cracks in the infrared reflecting coating.

### Example 4

A heat insulating laminated glass was produced in the same manner as in Example 2 except for using a PET film of 100 μm in thickness as the plastic film, forming acrylic hard coating films of 5 μm in thickness on both surfaces of the plastic film and forming, on one of the surfaces of the plastic film coated with the hard coating films, the same heat-ray reflecting film as that of Example 1.

Herein, the infrared reflecting coated plastic film sheet on which the hard coating films were formed had an elastic modulus of 1000 MPa at 130° C.

It was thus possible to obtain the curved heat insulating laminated glass with good appearance and with no wrinkles in the plastic film sheet with the infrared reflecting coating and no cracks in the infrared reflecting coating.

### Comparative Example 1

A laminated glass was produced in the same manner as in Example 1 except for using a PET film sheet with no infrared reflecting coating in place of the plastic film sheet 15 with the infrared reflecting coating.

The produced laminated glass had a solar transmittance of 47.2% that was higher than that of Example 1 using the plastic film sheet with the infrared reflecting coating, and showed heat insulating properties inferior to those of Example 1.

### Comparative Example 2

A laminated glass was produced in the same manner as in Example 1 except that: the interior glass plate 17 used was the same colorless transparent float glass of 3 mm in thickness (solar transmittance Te: 85.5%, visible light transmittance Tv: 90.4%) as the exterior glass plate 13; and the interior intermediate film 16 used was the same colorless transparent PVB film as the exterior intermediate film 14.

The produced laminated glass had a solar transmittance of 60.8% that was higher than that of Example 1, and showed heat insulating properties inferior to those of Example 1.

### Comparative Example 3

A heat insulating laminated glass was produced in the same manner as in Example 2 except for using no infrared reflecting coating of dielectric films.

The produced laminated glass had a solar transmittance of 50.2% that was higher than that of Example 2, and showed heat insulating properties inferior to those of Example 2.

### Comparative Example 4

A heat insulating laminated glass was produced in the same manner as in Example 2 except that the curved glass plate 24 used was the same glass plate as the curved glass plate 20. The produced laminated glass had a solar transmittance of 53.0% that was higher than that of Example 2, and showed heat insulating properties inferior to those of Example 2.

1. A heat insulating laminated glass, comprising:
at least two glass plates; and
an intermediate film member by which said at least two glass plates are laminated together,
wherein the intermediate film member has two intermediate films and a functional plastic film sheet arranged between the two intermediate films and formed with an infrared reflecting layer and an infrared absorbing layer.

2. The heat insulating laminated glass according to claim 1, wherein the infrared reflecting layer is in the form of either a multilayer film laminate that has oxide films of high and low refractive indexes alternately laminated on each other, a multilayer film laminate that has two kinds of polymer thin films of different refractive indexes alternately laminated on each other, or a metal film.

3. The heat insulating laminated glass according to claim 1, wherein the infrared absorbing layer is in the form of either a plastic film having conductive fine particles dispersed therein, a plastic film laminate that has a plastic film and a resin film having conductive fine particles dispersed therein and formed on a surface of the plastic film, a plastic film having an infrared absorbing pigment dispersed therein, or a plastic film laminate that has a plastic film and a resin film having an infrared absorbing pigment dispersed therein and formed on a surface of the plastic film.

4. The heat insulating laminated glass according to claim 1, wherein one of the intermediate films arranged in contact with the infrared absorbing layer contains therein conductive fine particles as an infrared absorbing material.

5. The heat insulating laminated glass according to claim 1, wherein one of the intermediate films arranged in contact with the infrared absorbing layer contains therein either a pigment or a dye as an infrared absorbing material.

6. The heat insulating laminated glass according to claim 1, wherein the heat insulating laminated glass has a visible light transmittance of 70% or higher and is used for an automotive window.
